(19) United States
(12) Patent Application Publication
(10) Pub. No.: US 2024/0284393 A1
(43) Pub. Date: Aug. 22, 2024

(54) SYSTEMS AND METHODS FOR IMPROVING POSITIONING OF USER EQUIPMENT

(71) Applicant: ZTE Corporation, Shenzhen (CN)

(72) Inventors: Di ZONG, Shenzhen (CN); Chuangxin JIANG, Shenzhen (CN); Yu PAN, Shenzhen (CN); Junpeng LOU, Shenzhen (CN)

(73) Assignee: ZTE Corporation, Shenzhen (CN)

(21) Appl. No.: 18/653,682

(22) Filed: May 2, 2024

Related U.S. Application Data
(63) Continuation of application No. PCT/CN2022/106321, filed on Jul. 18, 2022.

(51) Int. Cl. H04W 64/00

(52) U.S. Cl. CPC H04W 64/00

(57) ABSTRACT

Presented are systems, methods, apparatuses, or computer-readable media for positioning. A wireless communication node may identify a condition associated with a positioning method related to a wireless communication device. The wireless communication node may determine a value of a qualification flag based on whether at least one of a measurement result or assistance data associated with the positioning method satisfies the condition.

### CROSS-REFERENCE TO RELATED APPLICATION

This application claims the benefit of priority under 35 U.S.C. § 120 as a continuation of PCT Patent Application No. PCT/CN2022/106321, filed on Jul. 18, 2022, the disclosure of which is incorporated herein by reference in its entirety.

### TECHNICAL FIELD

The disclosure relates generally to wireless communications, including but not limited to systems and methods for positioning of user equipment (UEs).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, a method, an apparatus, or a computer-readable medium for positioning. A wireless communication node may identify a condition associated with a positioning method related to a wireless communication device. The wireless communication node may determine a value of a qualification flag based on whether at least one of a measurement result or assistance data associated with the positioning method satisfies the condition.

In some embodiments, the qualification flag may be configured for the specific wireless communication node for the specific positioning method. In some embodiments, the wireless communication node may perform a logic operation on a plurality of error sources associated with the specific positioning method to determine the value of the qualification flag.

In some embodiments, the qualification flag may be configured based on a specific Positioning Reference Signal (PRS) resource. In some embodiments, the qualification flag may be configured based on a specific Positioning Reference Signal (PRS) frequency layer. In some embodiments, the qualification flag may be configured for the specific positioning method.

In some embodiments, the wireless communication node may report, to a core network, the value of qualification flag set by the wireless communication device. In some embodiments, the wireless communication node may calculate the value of qualification flag. In some embodiments, the wireless communication node may report to a core network, the value of qualification flag.

In some embodiments, the wireless communication node may receive, from a core network, a message indicating the condition. In some embodiments, the message may be transmitted through at least one of: a Medium Access Control (MAC) layer or a Radio Resource Control (RRC) layer.

In some embodiments, the wireless communication node may receive, from a core network, a message indicating a plurality of positioning methods and their respective integrity parameters. In some embodiments, the wireless communication node may report, to the core network, a value of a qualification flag associated with each of the plurality of positioning methods.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an example downlink positioning methods qualification configuration procedure in accordance with an illustrative embodiment;

FIG. 4 illustrates a block diagram of an example uplink positioning methods qualification configuration procedure in accordance with an illustrative embodiment;

FIG. 5 illustrates a block diagram of an example mapping among positioning methods and measurements in accordance with an illustrative embodiment; and

FIG. 6 illustrates a flow diagram of a process for positioning of wireless communication devices in accordance with an illustrative embodiment.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 1. Mobile Communication Technology and Environment

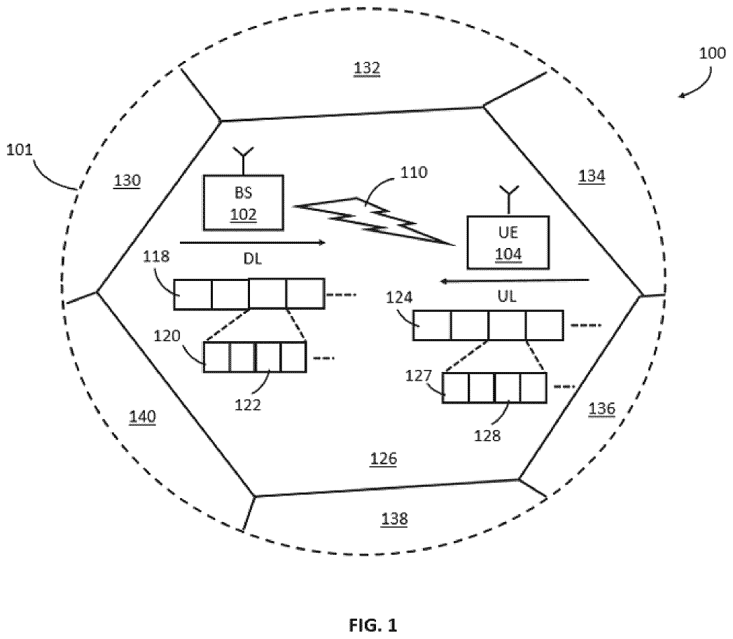

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100”. Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

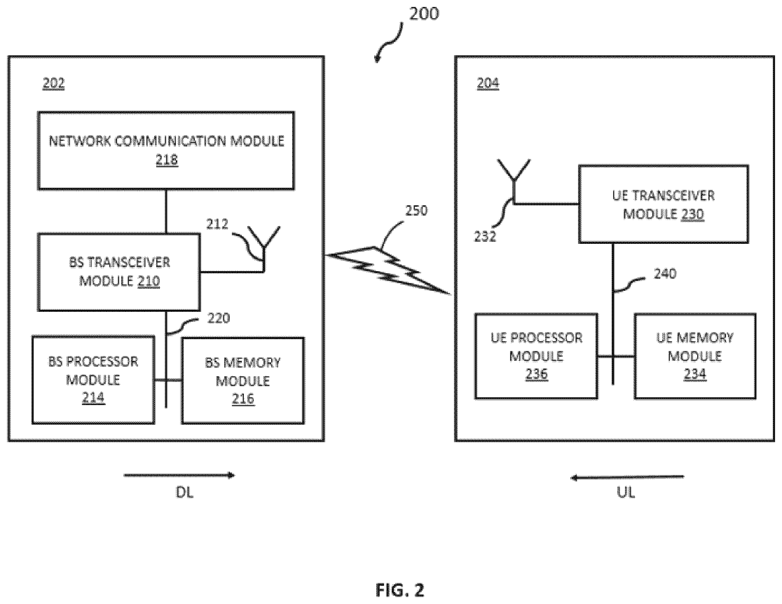

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Improving Positioning of User Equipment

Positioning integrity may be considered for a global navigation satellite system (GNSS) positioning method and assisted-GNSS positioning method. The positioning integrity may provide a method to evaluate the trustworthiness of the position estimates. The scope of the such positioning integrity may be restricted to the radio access technology (RAT)-Independent positioning methods under certain approaches. Expanding the positioning integrity method into RAT-Dependent positioning and identifying ways to perform the signaling transmitting procedures between a location management function (LMF) and a user equipment (UE) for RAT-Dependent positioning integrity may also be considered. Presented herein are systems and methods for performing signaling procedures for RAT-Dependent positioning methods. Below are described detailed contents that are considered to be transmitted or reported during reporting the procedure.

Positioning integrity may be a measure of the trust in the accuracy of the position-related data provided by the positioning system and the ability to provide timely and valid warnings to the location service (LCS) client when the positioning system does not fulfil the condition for intended operation. For statistical evaluation, a protection level (PL) may be defined for measuring the real-time upper bound of the positioning error at the specified degree of confidence. The degree of confidence may be determined by the target integrity risk (TIR) probability. The PL may be dependent on various factors, such as the TIR, time to alert (TTA), positioning error (PE), among others. The PL may satisfy, for example, the following inequality:

$$Prob per unit of time [ ( ( P E > A L ) \& ( P L <= A L ) ) for longer than T T A ] < required T I R \qquad ( Equation 2.1 )$$

When the PL bounds the positioning error in the horizontal plane or on the vertical axis, then it may be referred to as a Horizontal Protection Level (HPL) or Vertical Protection Level (VPL) respectively. A specific equation for the PL may not be specified as this is implementation-defined. For the PL to be considered valid, the PL should satisfy the inequality above.

### Embodiment 1: Radio Access Technology (RAT) Dependent Positioning Methods

In general, positioning integrity may be a measure of the trust in the accuracy of the position-related data provided by the positioning system and the ability to provide timely and valid warnings to the LCS client, when the positioning system does not fulfil the condition for intended operation. Positioning integrity monitoring may be already supported by GNSS service providers. There may be some standard for expanding the ecosystem of connected devices which can benefit from positioning integrity.

Hence, it may be beneficial to extend the integrity procedure for A-GNSS to RAT dependent positioning including all wireless positioning methods (e.g., as defined in Rel-16 and 17), so that the integrity can enable applications or LCS client to make the correct decisions. For example, when wireless positioning system cannot provide enough accurate positioning service for an automatic driving use case, the system can trigger feared event report to LCS client for warning, and then driving mode can be switched to manual driving for safety.

In order to extend positioning integrity to RAT-Dependent positioning methods, new error sources and integrity parameters specified for RAT-Dependent positioning methods may be considered. The error sources for RAT-Dependent positioning methods may include the following. In timing-based positioning methods, the error sources may include transmission/reception point (TRP) or UE measurement errors (e.g., a time of arrival (ToA) and reception-transmission timing difference, among others) and errors in assistance data (e.g., TRP location, inter-TRP synchronization errors), among others. Under angle-based positioning methods, the error sources may include a TRP or UE measurement errors (e.g., angle of arrival (AoA), a reference signal received power (RSRP), a reference signal received path power (RSRPP)) and errors in assistance data (e.g., TRP location and TRP beam antenna information), among others. There may be additional sources of error for other positioning methods, such as sidelink positioning.

The integrity parameters may be included in the new radio (NR)-specific assistance data information. The parameters may include errors (e.g., origin of error sources as discussed above) and bounds. Integrity bounds may provide the statistical distribution of the residual errors associated with RAT-Dependent positioning methods. The bound may be computed according to the Equation 2.1 as discussed above. In the form of mean and standard deviation used in the integrity overbounding model, the bounds may correspond to specific error sources. These sources may be reported to the LCS at the UE-side or the location management function (LMF)-side according to the error source and positioning methods.

For error sources from assistance data (e.g., TRP location), the bound may be calculated at LMF side. For error sources from measurement results, the bound may be calculated at the UE-side in downlink positioning methods (e.g., downlink time difference of arrival (DL-TDOA)). The bound may be calculated at the gNB-side in uplink positioning methods (e.g., uplink angle of arrival (UL-AOA)). Bounds may be reported per TRP.

Regarding qualification flags, if the condition provided in assistance data cannot be met during the valid time, the TRP may not be reported for integrity computing and the qualification flags should be set true. The qualification flags may correspond to particular errors. Regarding thresholds, the threshold may represent the condition mentioned in the qualification flag segment above. Regarding TTA, the TTA may define the maximum allowable elapsed time from when the Error exceeds the bound until a qualification flag is to be issued. Under RAT-Dependent positioning methods, TTA can be configured per positioning reference signal (PRS) resource. In addition, the allowable values for integrity risk allocation maximum and minimums (IRmax and IRmin) may be selected by the client. The values may be provided as service parameters from the network according to integrity service parameters. For bound computation, the values may be provided the service parameters from the network.

### Embodiment 2: Qualification Flags Configuration

The qualification flags may correspond to particular errors. If the condition provided in assistance data cannot be met during the valid time, the qualification flags may be set true. In RAT-Dependent positioning method, a qualification flag can be reused to inform the computing entity if all kinds of measurement results or errors in assistance data are valid for integrity computation. For example, in DL-TDOA positioning method, the ToA may be considered as one of the potential error source which can influence the integrity results during the procedure. In this TRP for integrity computation, if the ToA in measurement results is poor enough, the qualification flag configured in this TRP may be set true so that the PL computation in this TRP should be terminated.

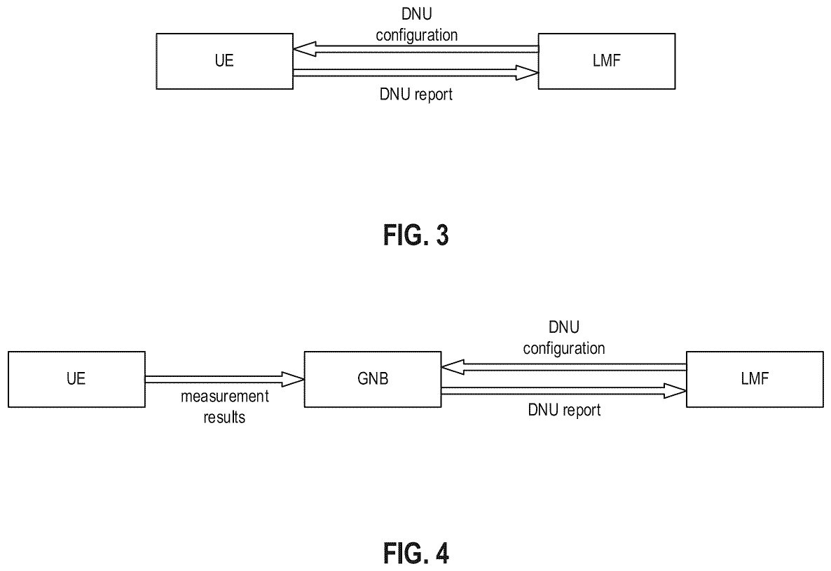

The general procedures of qualification flags configuration are shown in the FIGS. 3 and 4 for both downlink positioning methods and uplink positioning methods, considering the error source origins from both measurement results and assistance data. FIG. 3 illustrates downlink positioning methods qualification configuration procedure. FIG. 4 illustrates uplink positioning methods qualification configuration procedure. As to the granularity for qualification flag configuration, there may be four cases to be considered as set out below.

### Case 1

Qualification flags may be configured per TRP for each positioning method. This case may consider the measurement results are transferred in assistance data per TRP. The examples of RRC configuration are as follows:

CASE 2

NR-DL-PRS-AssistanceDataPerTRP-r16 ::= SEQUENCE {

| dl-PRS-ID-r16 | INTEGER (0..255), | |
|---|---|---|
| nr-PhysCellID-r16 | NR-PhysCellID-r16 | OPTIONAL, |

-- Need ON

| | | |
|---|---|---|
| nr-CellGlobalID-r16 | NCGI-r15 | OPTIONAL, |

-- Need ON

| | | |
|---|---|---|
| nr-ARFCN-r16 | ARFCN-ValueNR-r15 | OPTIONAL, |

-- Need ON

| | |
|---|---|
| nr-integrityQualification-r18 | Boolean |

...
}

Considering that error sources may origin from beam information, qualification flags can be configured per PRS resource. The integrity result may be monitored per beam and the flag may be set true if the beam information can not satisfy some condition. The example of RRC configuration is as follows:

CASE 3

DL-PRS-ResourceSets-TRP-Element-r16 ::= SEQUENCE {

| | | |
|---|---|---|
| dl-PRS-ResourceSetARP-r16 | RelativeLocation-r16 | OPTIONAL, -- |

Need OP

| | |
|---|---|
| dl-PRS-Resource-ARP-List-r16 | SEQUENCE |

(SIZE(1..nrMaxResourcesPerSet-r16)) OF DL-PRS-Resource-ARP-

| | | |
|---|---|---|
| Element-r16 | OPTIONAL, | -- Need OP |

| | |
|---|---|
| nr-integrityQualification-r18 | Boolean |

...
}

Considering that some error sources such as synchronization between TRPs and TRP location, if the qualification flag is configured per TPR, these error sources may not be covered. To account for these, qualification flags may be configured from a larger scale such as PRS frequency layer. The example of RRC configuration is as follows

CASE 4

NR-DL-PRS-AssistanceDataPerFreq-r16 ::= SEQUENCE {
nr-DL-PRS-PositioningFrequencyLayer-r16 NR-DL-PRS-
PositioningFrequencyLayer-r16,
nr-DL-PRS-AssistanceDataPerFreq-r16 SEQUENCE (SIZE
(1..nrMaxTRPsPerFreq-r16)) OF NR-DL-PRS-AssistanceDataPerTRP-
r16,
nr-integrityQualification-r18 Boolean
...
}

Since the type of the error source varies in different positioning methods and so does the condition for setting the qualification flag, the flag may be configured per positioning method. The example of RRC configuration is as follows:

```
NR-DL-TDOA-ProvideAssistanceData-r16 ::= SEQUENCE {
nr-DL-PRS-AssistanceData-r16 NR-DL-PRS-AssistanceData-r16
  OPTIONAL, -- Need ON
nr-SelectedDL-PRS-IndexList-r16 NR-SelectedDL-PRS-
IndexList-r16 OPTIONAL, -- Need ON
nr-PositionCalculationAssistance-r16
    NR-PositionCalculationAssistance-r16
nr-integrityQualification-tdoa-r18 Boolean
...
]
```

For qualification flags reporting, the result may be reported per positioning method. For example, under DL-TDOA, the reporting may be set as follows:

NR-DL-TDOA-MeasElement-r16 ::= SEQUENCE {
dl-PRS-ID-r16 INTEGER (0..255),
nr-integrityQualification-r18 Boolean
...
}

### Embodiment 3: Location Management Function (LMF) Informing Measurement Results

To report a precise qualification flag, the UE and gNB may obtain whether the measurement results from the potential error resources are poor enough. Therefore, LMF may inform the UE or gNB of the threshold for each measurement result from potential error sources. In the TRP for integrity computing, if the measurement results are poorer than the expected threshold, the flag may be set to true.

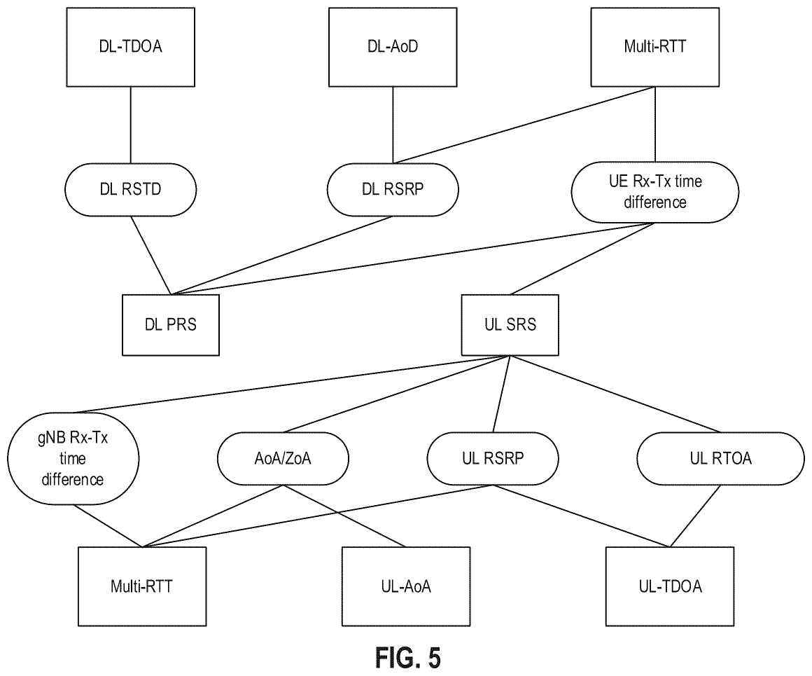

Since the type of error sources varies according to the positioning methods, the measurement threshold may be configured per method. FIG. 5 shows the mapping between the positioning methods and measurements. The procedure may be as follows. The threshold can be set on a media access control (MAC) layer or a radio resource control (RRC) layer. The comparison between measurement results and the threshold occurs may occur in different entities. For downlink positioning methods (e.g., DL-TDOA), the UE may calculate qualification flags for measurement. For uplink positioning methods (e.g., UL-AOA), the gNB may calculate the results and report the qualification flag. The corresponding computing entity may send the qualification flag back to the LMF.

The threshold can be configured as follows (with DL-TDOA as an example):

```
NR-DL-TDOA-ProvideAssistanceData-r16 ::= SEQUENCE {
nr-DL-PRS-AssistanceData-r16 NR-DL-PRS-AssistanceData-r16
  OPTIONAL, -- Need ON
nr-SelectedDL-PRS-IndexList-r16 NR-SelectedDL-PRS-
IndexList-r16 OPTIONAL, -- Need ON
nr-PositionCalculationAssistance-r16 NR-
PositionCalculationAssistance-r16 OPTIONAL, -- Cond UEB
nr-DL-TDOA-Error-r16 NR-DL-TDOA-Error-r16
  OPTIONAL, -- Need ON
nr-DL-TDOA-threshold-r18 INTEGER
...,a
}
```

### Embodiment 4: Location Services (LCS) Informing Number of Transmission/Reception Points

In RAT-dependent positioning procedure, the maximum number of TRP per frequency layer may be, for example, 64. Therefore, there may be redundancy, if the integrity result is reported to LCS in each TRP. To resolve this, the LCS can inform the computation entity of the number of TRPs which report integrity results. The computation entity may select the corresponding TRPs according to the number.

The procedure may be as follows. The LMF may inform the UE or gNB of the numbers of TRPs used for integrity reporting in assistance data. The numbers can be configured, for example, in the following manner:

NR-DL-PRS-AssistanceDataPerFreq-r16 ::= SEQUENCE {
nr-DL-PRS-integrity-numofTRP INTEGER
...
}

Continuing on, the UE or gNB determines which TRPs are used to report integrity results. The computation entity can identify TRPs that have best measurement results. The best measurement results may be acquired through the comparison mentioned in the segment above. For reference signal time difference (RSTD), the reference TRP may be used, and the flag may be set to false. The UE or gNB may feedback the TRP ID used for reporting integrity results to LMF. The signaling for choosing TRPs can be at least one of the following: MAC layer or RRC layer.

### Embodiment 5: Combination of Multiple Positioning Methods

There may be some cases where multiple positioning methods are combined for positioning. Different from single positioning method, error sources may be defined for all positioning methods included in the procedure. In addition, since qualification flags and bounds correspond to specific error sources, the qualification flags may be reported to LMF per method. When multiple qualification flags are specified, the qualification condition in equation 2.2 may be present when any of the flags are set to true. The integrity result may rely on all the positioning methods included.

The procedure can be as follows. The LMF may inform the UE or the gNB of multiple positioning methods and provide corresponding integrity parameter in assistance data accordingly, including threshold, numbers of TRPs used for integrity computing, TTA, and TIR, among others. For each method, UE or gNB may report measurement results and corresponding qualification flags. The computing entity may calculate and report corresponding bounds and PL values. The LMF may combine the reporting information and may conclude the integrity results.

### Embodiment 6: Processes for Positioning of Wireless Communication Devices

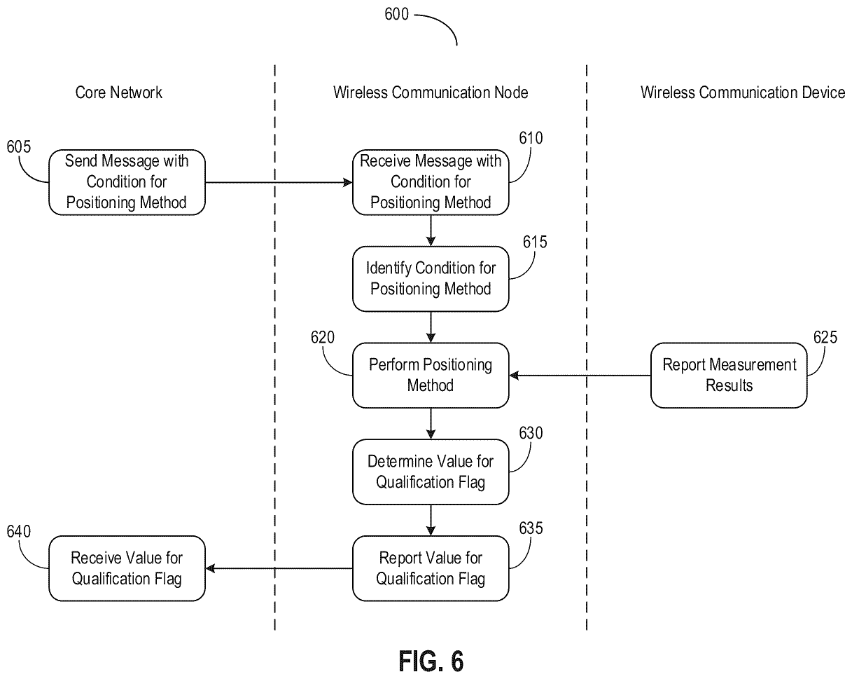

Referring now to FIG. 6, depicted is a flow diagram of a process 600 for positioning of wireless communication devices. The process 600 may be performed by or implemented using any of the components described herein, such as a base station 102 or 202 and a user equipment (UE) 104 or 204, among others. Under the process 600, a core network may send a message with a condition for a positioning method to a wireless communication node (605). The wireless communication node may receive the message with the condition for the positioning method (610). The wireless communication node may identify the condition for the positioning method (615). The wireless communication node may perform positioning (620). The wireless communication device may report measurement results (625). The wireless communication node may determine a value for a qualification flag (630). The wireless communication node may report the value for the qualification flag (635). The core network may receive the value for the qualification flag (640).

In further detail, a core network (e.g., a location management function) may provide, transmit, or otherwise send a message with a condition for a positioning method to a wireless communication node (e.g., the base station 102 or 202 or a transmission/reception point (TRP)) (605). The condition may identify a threshold or other constraint to be satisfied when performing the positioning method related to a wireless communication device (e.g., a user equipment 104 or 204). The positioning method may be radio access technology (RAT)-dependent method. The positioning method may include, for example, a timing-based positioning method or an angle-based positioning method, among others, in uplink or downlink configurations.

The message may include, identify, or otherwise indicate the condition associated with a positioning method. In some embodiments, the message may include or identify assistance data including the condition for the positioning method. The message may also indicate one or more positioning methods to be performed. The message may identify multiple positioning methods to be performed. For each positioning method, the message may one or more corresponding integrity parameters. The integrity parameters may be particular to the type of positioning method to be performed, and may be included as part of assistance data associated with the positioning method. In some embodiments, the message may be communicated or transmitted through a media access control (MAC) layer or a radio resource control (RRC) layer. The wireless communication node may identify, retrieve, or otherwise receive the message with the condition for the positioning method from the core network (610).

The wireless communication node may determine or otherwise identify the condition associated with the positioning method related to the wireless communication device (615). Upon receipt from the core network, the wireless communication node may extract or identify the condition for the positioning method from the message. In some embodiments, the wireless communication node may identify the condition for each positioning method indicated in the message. The wireless communication node may identify the integrity parameters corresponding to the positioning method.

The wireless communication node may carry out or perform the positioning method with the wireless communication device in accordance with the positioning method (620). As discussed above, the positioning method may include, for example, the timing-based positioning method or the angle-based positioning method, among others, in uplink or downlink configurations. In some embodiments, the wireless communication node may perform each positioning method as identified by the message.

The wireless communication device may provide, transmit, or otherwise report measurement results to the wireless communication node (625). In performing the positioning method, the wireless communication device may calculate, determine, or otherwise generate the measurement results in accordance with the positioning method. For example, when the positioning method is timing-based, the wireless communication device may determine time of arrival (ToA) or reception-transmission timing difference, among others. When the positioning method is angle-based, the wireless communication device may determine angle of arrival (AoA), a reference signal received power (RSRP), and a reference signal received path power (RSRPP), among others. From performing the wireless communication node may receive, retrieve, or otherwise identify the measurement results for the positioning method from the wireless communication device.

The wireless communication node may calculate, set, or otherwise determine a value for a qualification flag (630). In some embodiments, the wireless communication node may determine the value for the qualification flag for each positioning method performed. The value for the qualification flag may be associated with the positioning method. For instance, the qualification flag may correspond to one or more errors associated with the positioning method. In some embodiments, the wireless communication node may determine the value for the qualification flag, for each positioning method performed. In some embodiments, the qualification flag may be configured for the specific wireless communication node for the specific positioning method. In some embodiments, the wireless communication node may retrieve or identify the value for the qualification flag set by the wireless communication device.

To calculate or set the value for the qualification flag, the wireless communication node may determine whether the measurement result or the assistance data associated with the positioning method satisfies the condition. The determination may be based on whether the measurement results or the assistance data satisfy the condition within a set period of time. In some embodiments, the wireless communication node may carry out, execute, or otherwise perform a logic operation on a plurality of error sources associated with the specific positioning method to determine the value of the qualification flag. The logic operation may specify, define, or otherwise identify a combination (e.g., integrity bounds) of error sources associated with the specific positioning method. The error sources may be dependent on the type of positioning method (e.g., timing-based, angle-based, and other methods).

Based on the determination, the wireless communication node may set the value for the qualification flag. When the measurement results or the assistance data satisfies the condition, the wireless communication node may set the qualification flag to a first value (e.g., a Boolean value of true). For example, if the measurement errors are within a threshold defined by the condition, the wireless communication node may set the qualification flag to true. On the other hand, when the measurement results or the assistance data does not satisfy the condition, the wireless communication the qualification flag to a second value (e.g., a Boolean value of false). For example, if the measurement errors are outside a threshold defined by the condition, the wireless communication node may set the qualification flag to true.

The qualification may be configured (e.g., by the wireless communication node) using a RRC configuration. In some embodiments, the qualification flag may be configured on a per wireless communication node (e.g., TRP) basis for each positioning method performed. In some embodiments, the qualification flag may be configured) based on a specific positioning reference signal (PRS) resource. The PRS may be a reference signal used for positioning methods, and the PRS resource may, for example, correspond to a beam. In some embodiments, the qualification flag may be configured based on a specific PRS frequency layer. The PRS frequency layer may, for example, correspond to a frequency layer for the PRS. In some embodiments, the qualification value may be configured for the specific positioning method.

The wireless communication node may provide, transmit, or otherwise report the value for the qualification flag to the core network (635). The value of the qualification flag may be reported with the corresponding measurement results or the assistance data associated with the positioning method. In some embodiments, the value for the qualification flag reported to the core network may be set by the wireless communication device. In some embodiment, the wireless communication may report the value for the qualification flag associated with each of the positioning methods performed. The core network may identify, retrieve, or otherwise receive the value for the qualification flag from the wireless communication node (640). In some embodiments, the core network may receive the value for the qualification flag, along with the corresponding measurements or the assistance data, from the wireless communication node. Using the value for the qualification flag, the measurement results, and the assistance data, the core network may determine the integrity results for the positioning method.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A wireless communication method, comprising:
identifying, by a wireless communication node, a condition associated with a positioning method related to a wireless communication device; and
determining, by the wireless communication node, a value of a qualification flag based on whether at least one of assistance data associated with the positioning method satisfies the condition.

2. The wireless communication method of claim 1, wherein the qualification flag is configured based on a specific Positioning Reference Signal (PRS) frequency layer.

3. The wireless communication method of claim 1, wherein the qualification flag is configured for the specific positioning method.

4. The wireless communication method of claim 1, wherein the qualification flag is configured based on a specific transmission reception point (TRP) for the positioning method.

5. A wireless communications node, comprising:
one or more processors configured to:
identify a condition associated with a positioning method related to a wireless communication device; and
determine a value of a qualification flag based on whether at least one of assistance data associated with the positioning method satisfies the condition.

6. The wireless communications node of claim 5, wherein the qualification flag is configured based on a specific Positioning Reference Signal (PRS) frequency layer.

7. The wireless communication node of claim 5, wherein the qualification flag is configured for the positioning method.

8. The wireless communication node of claim 5, wherein the qualification flag is configured based on a specific transmission reception point (TRP) for the positioning method.

9. A wireless communication method, comprising:
performing, by a wireless communication device, a positioning method in accordance with at least one of assistance data, and
wherein a wireless communication node is configured to determine a value of a qualification flag based on whether at least one of the assistance data associated with the positioning method satisfies the condition.

10. The wireless communication method of claim 9, wherein the qualification flag is configured based on a specific Positioning Reference Signal (PRS) frequency layer.

11. The wireless communication method of claim 9, wherein the qualification flag is configured for the positioning method.

12. The wireless communication method of claim 9, wherein the qualification flag is configured based on a transmission reception point (TRP) for the positioning method.

13. The wireless communication method of claim 9, wherein receiving the assistance information further comprises receiving the assistance information from the wireless communication node.

14. A wireless communication device, comprising:
one or more processors configured to:
perform a positioning method in accordance with at least one of assistance data, and
wherein a wireless communication node is configured to determine a value of a qualification flag based on whether at least one of the assistance data associated with the positioning method satisfies the condition.

15. The wireless communication method of claim 14, wherein the qualification flag is configured based on a specific Positioning Reference Signal (PRS) frequency layer.

16. The wireless communication method of claim 14, wherein the qualification flag is configured for the positioning method.

17. The wireless communication method of claim 14, wherein the qualification flag is configured based on a transmission reception point (TRP) for the positioning method.

18. The wireless communication method of claim 14, wherein receiving the assistance information further comprises receiving the assistance information from the wireless communication node.

19. A non-transitory computer program product comprising a computer-readable program medium code stored thereupon, the computer-readable program medium code, when executed by a processor, causing the apparatus to perform the wireless communication method recited in claim 1.

20. A non-transitory computer program product comprising a computer-readable program medium code stored thereupon, the computer-readable program medium code, when executed by a processor, causing the apparatus to perform the wireless communication method recited in claim 9.
